(19) United States
(12) Patent Application Publication
(10) Pub. No.: US 2013/0029645 A1
(43) Pub. Date: Jan. 31, 2013

(54) CALL SWITCHING SYSTEM AND METHOD FOR COMMUNICATION DEVICES

(71) Applicant: Philip Schentrup, Hollywood, FL (US)

(72) Inventor: Philip Schentrup, Hollywood, FL (US)

(73) Assignee: OpenPeak Inc., Boca Raton, FL (US)

(21) Appl. No.: 13/192,398

(22) Filed: Jul. 27, 2011

(51) Int. Cl. H04W 4/00

(52) U.S. Cl. 455/414.1

(57) ABSTRACT

A communication system includes a communication device (i.e., a cellular or smart phone) communicatively coupled to an auxiliary communication device (i.e. a headset). Systems and methods are provided for switching between calls in instances in which there are at least three calls being simultaneously supported. In one embodiment, a prediction can be made as to which one of the pending calls should be resumed when an active call is terminated or put on hold. The prediction can be made based on any suitable criterion, including, for example, the frequency of calls received from or made to a caller, the amount or percentage of accepted calls from a caller, the duration of calls received from or made to a caller, and/or a ranking input by a user. Such predictive analysis can minimize the need for a user to cumbersomely navigate through a call list to reach a desired call.

### FIELD

Embodiments relate in general to communication devices and, more particularly, to communication devices adapted to simultaneously support more than two phone calls.

### BACKGROUND

Bluetooth (BT) enabled handsfree devices were originally intended for phone applications in which there are at most two active calls at any one time. The interface between the BT handsfree device and the phone, as implemented by device manufacturers, is optimized to exploit the fact that only two calls exist at any time, and certain assumptions are made about how to hold/resume calls and terminate/resume calls. However, on devices that support more than two simultaneous calls, these optimizations and assumptions can make navigation through an active call list via the BT headset frustrating and cumbersome, as the user may have to repeatedly hold/resume calls and/or terminate/resume calls until the desired call is reached.

For instance, a user may have to progress through the calls sequentially based on the order in each call was received. However, as the number of calls on hold increases, the process can become tiresome, especially if the desired call is the last call or near the last call in the sequence. As an example, if the device is supporting five calls and the user places the current call on hold or terminates the call, the user may have to resume and hold/terminate as many as three calls before the desired call in the sequence is resumed.

Thus, there is a need for a system and method that can minimize such concerns.

### SUMMARY

In one respect, embodiments are directed to a method of switching between calls on a communication system.

The system has at least three simultaneously supported calls (active and pending calls) thereon. According to the method, a prediction is made as to which one of the supported calls should be resumed when another one of the supported calls is terminated or put on hold. The predicted call is resumed for output on a communication device. The communication device can be a portable communication device, a cellular phone, a smart phone, a tablet computer, a computer, a personal digital assistant, or an entertainment device. Alternatively, the communication device can be an auxiliary communication device operatively connected to output calls received by another communication device thereon. The auxiliary communication device can be a handsfree device or a Bluetooth headset. The step of predicting which of the supported calls to resumed can be performed on a communication device that is different than the one on which the predicted call is resumed. In some instances, the predicting can be performed on the same communication device as the one on which the predicted call is resumed.

The step of predicting which one of the supported calls should be resumed can be based at least partially on data associated with the usage of the communication device. In one embodiment, the predicting can comprise determining which of the supported calls has the greatest number of entries in a call history of the communication device. Alternatively or in addition, the predicting can comprise determining which of the supported calls has the greatest number or percentage of accepted calls from a caller in a call history of the communication device. Still alternatively or in addition, the predicting can comprise determining which of the supported calls has the highest ratio of accepted calls to rejected calls in a call history of the communication device. Yet still alternatively or in addition, the predicting can comprise determining which of the supported calls has the greatest single or collective call duration in a call history of the communication device.

In one embodiment, the predicting can comprise determining the highest ranked supported call based on a rank associated with each caller. A rank can be automatically assigned to a caller if a rank has not previously been assigned by a user.

In some instances, the predicting can be at least partially based on the user's call switching frequency or another temporal characteristic of the user's usage of the communication device. The predicting can comprise determining the geographic proximity of the communication device to the location of the supported calls. Calls originating from closer locations may be assigned a higher or increased priority over more distant calls. Alternatively, calls originating from more distant locations may be assigned a higher or increased priority over more local calls. In one embodiment, the predicting can be at least partially based on data associated with the user's social media accounts.

The predicting can be an average of a plurality of factors. The average may be a weighted average. The weight associated with each factor comprising the average can be adaptive and can be modified by the user or automatically.

The method may further include terminating or holding the resumed call, predicting a next one of the supported calls to resume when the resumed call is terminated or put on hold, and resuming the next predicted call for output on the communication device. In such case, the predicting can be based on a different criterion other than the previous predicting step.

In another respect, embodiments are directed to a communication system. The communication device includes a processor configured to switch between at least three pending calls being simultaneously supported by the communication system. The processor is configured to predict one of the supported calls to resume when another one of the supported calls is terminated or put on hold, and resume the predicted call for output on a communication device. The processor can be provided in the communication device on which the predicted call is resumed. Alternatively, the processor can be provided in a different communication device than the communication device on which the predicted call is resumed.

The prediction can be based at least partially on data associated with the usage of the communication device. For example, the prediction can comprise determining which of the supported calls has (a) the greatest number of entries in a call history of the communication device; (b) the greatest number or percentage of accepted calls from a caller in a call history of the communication device; (c) the highest ratio of accepted calls to rejected calls in a call history of the communication device; or (d) the greatest single or collective call duration in a call history of the communication device.

As an alternative, the prediction can comprise determining the highest ranked supported call based on a rank associated with each caller. In some instance, the processor can be configured so that a rank is automatically assigned to a caller if a rank has not previously been assigned by a user.

The communication device can be a portable communication device. The communication device can be a cellular phone, a smart phone, a tablet computer, a computer, a personal digital assistant or an entertainment device. The communication device can be an auxiliary communication device operatively connected to output calls received by another communication device thereon. In one embodiment, the auxiliary communication device can be a handsfree device, including, for example, a Bluetooth headset.

In still other respects, embodiments are directed to a method of switching between calls on a communication system adapted to simultaneously support at least three calls. According to the method, a plurality of incoming calls can be received. One or more of the incoming calls can be accepted such that, for each accepted call, any active call is placed on hold and the accepted call is activated for output on a communication device. A call list can be generated in which each accepted incoming call is placed on the call list after the previously active call. Thus, the call list can be non-sequentially ordered to facilitate progression through the call list.

The method can further include receiving an input to terminate the currently active call, terminating the currently active call, removing the terminated call from the call list, and resuming the call on the call list that was most recently active before the terminated call, regardless of the position of the call on the call list.

Additionally, the method can include receiving an input to place the currently active call on hold, placing the currently active call on hold, and resuming the call associated with the previous entry on the call list from the call placed on hold. Still further, the method can include receiving an input to resume a selected call from the call list, placing any active call on hold, resuming the selected call, and moving the selected call to immediately after the previously active call on the call list.

In some instances, the method can include receiving an input to terminate a particular call from the call list, terminating the selected call, removing the selected call from the call list, and resuming the call on the call list that was most recently active before the terminated call, regardless of the position of the call on the call list.

In yet another respect, embodiments are directed to a communication system. The system includes a processor configured to switch between at least three pending calls being simultaneously supported on the communication system. The processor is configured to place an active call on hold and activate the accepted call for output on a communication device in response to receiving an input to accept an incoming call.

The communication device can be a portable communication device. For example, the communication device is a cellular phone, a smart phone, a tablet computer, a computer, a personal digital assistant or an entertainment device. In one embodiment, the communication device can be an auxiliary communication device operatively connected to output calls received by another communication device thereon. The auxiliary communication device is a handsfree device. As an example, the handsfree device can be a Bluetooth headset. In one embodiment, the processor can be provided in the same communication device on which the accepted call is activated. Alternatively, the processor can be provided in a different communication device than the communication device on which the accepted call is activated.

The processor is configured to generate a call list in which each accepted incoming call is placed on the call list after the previously active call. Thus, the call list is non-sequentially ordered to facilitate progression through the call list. The processor can be further configured to terminate the currently active call when other calls are pending, remove the terminated call from the call list, and resume the call that was most recently active before the terminated call, regardless of the position of the call on the call list.

The processor can further configured to place the currently active call on hold, and resume the call associated with the previous entry on the call list from the call placed on hold. Further, the processor can be configured to resume a call selected from the call list, and move the selected call to immediately after the previously active call on the call list. Still further, the processor can be configured to terminate a call selected from the call list, and remove the selected call from the call list.

### BRIEF DESCRIPTION OF THE DRAWINGS

FIG. 1 shows a communication system.

FIG. 2 is a diagrammatic view of a communication device.

FIG. 3 is a diagrammatic view of an auxiliary communication device.

FIG. 4 shows an incoming call treatment method.

FIG. 5 shows a predictive call switching method.

FIG. 6 shows a call switching method.

### DETAILED DESCRIPTION

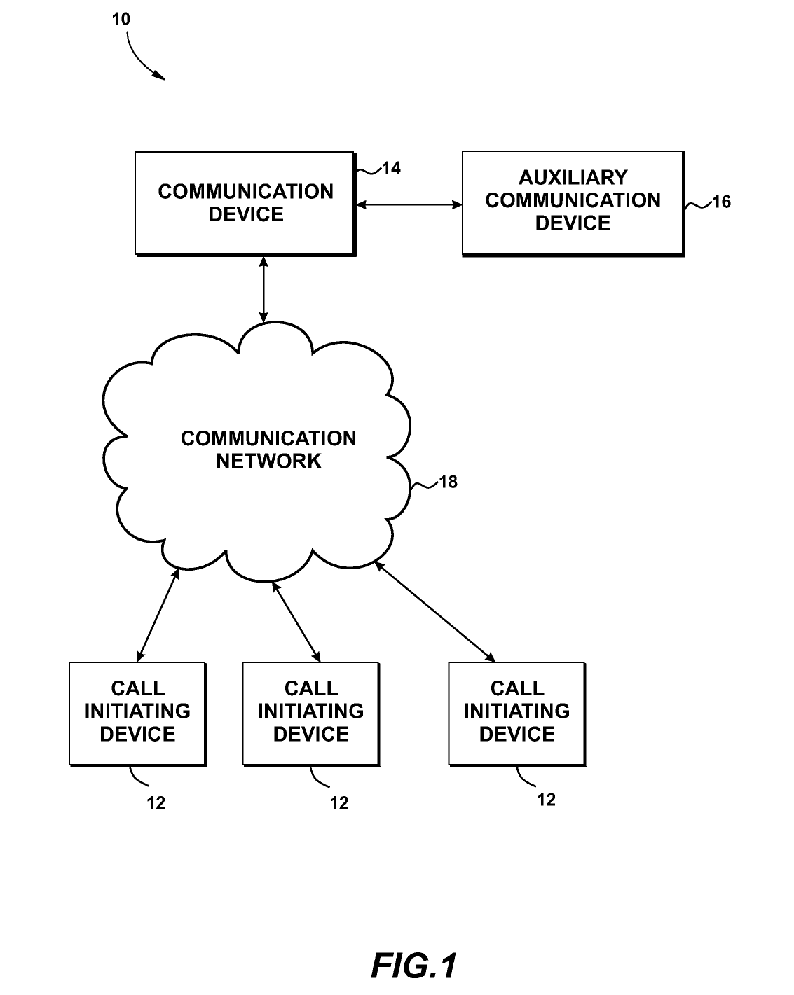

Arrangements described herein relate to call switching systems and methods for a communication device. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Again, call switching systems and methods for communication devices are described herein. Embodiments can be applied to call switching situations in which a user has only an option to resume a call on the communication device without having the ability to select the call. For example, the user may be presented with only a “Go to Next Call?” prompt on the communication device. In some instances, call switching systems and methods described herein can include predictive call switching protocols. “Predictive” means that the order in which calls are switched to is based at least in part on the evaluation of information, including information relating to the usage of a communication device, to determine which on hold call the user would most likely wish to resume. In other instances, call switching systems and methods described herein can be based on specific protocols depending on the particular input from the user. Systems and methods herein can improve a user's navigation through calls supported on the communication device.

Referring to FIG. 1, an exemplary system 10 is shown. The system 10 can include one or more call initiating devices 12, a communication device 14, and/or an auxiliary communication device 16. The one or more call initiating devices 12 can be communicatively coupled to the communication device 14 via a communication network 18. The communication network 18 can comprise the Internet, a wide area network (WAN), a local area network (LAN), wireless local area network (WLAN), a wireless communication network, and/or the like. The communication network 18 can include one or more components designed to transmit and/or receive information from one source to another. The communication network 18 can include wired communication links and/or wireless communication links.

If the system includes an auxiliary communication device 16, the communication device 14 can be communicatively coupled to the auxiliary communication device 16 by any suitable type of direct or network connection, including any of those described above as well as by Bluetooth, Bluetooth low energy (BLE), Infrared Data Association (IrDA), Ultra-wideband (UWB), Z-Wave, ZigBee and Near Field Communication (NFC), WiFi and/or direct wireless communication. Still, embodiments are not limited in this regard and the system can be configured to communicate signals in accordance with any suitable communications standards, protocols, and/or architectures, or a suitable combination of such standards, protocols, and/or architectures. Alternatively or in addition, the communication device and the auxiliary communication device can be communicatively linked by a wired connection, such as by Ethernet, Universal Serial Bus (USB), IEEE 1394 (FireWire), eExternal Serial ATA, etc.

The various components of the system will be described in greater detail below. The one or more call initiating devices 12 can be any source of a call, including data or voice calls. The term “call initiating devices” means any device or system which can receive voice (including spoken sounds) from a user and can at least partially facilitate the transmission of voice signals to another device, including, for example, over circuit switched or packet data networks. Examples of possible call initiating devices 12 include a land line telephone; a computer equipped with Voice over Internet Protocol (VoIP) technologies, communication protocols, and transmission technologies; and a communication device, such as a cellular telephone or a smart phone. The call initiating devices 12 can be adapted to communicate with the communication device 14, either directly or through the communication network 18 or through some other suitable medium.

The communication device 14 can be any suitable device including, for example, a cellular telephone, a smart phone, a personal digital assistant (“PDA”), a tablet computer, a handheld device having wireless connection capability, a computer (e.g., a laptop), a portable communication device, a portable computing device, an entertainment device, or any other suitable device that is configured to communicate via a wireless or wired medium. Embodiments described herein can be implemented into any suitable communication device, including any of those listed above. The communication device 14 may implement any suitable operating system.

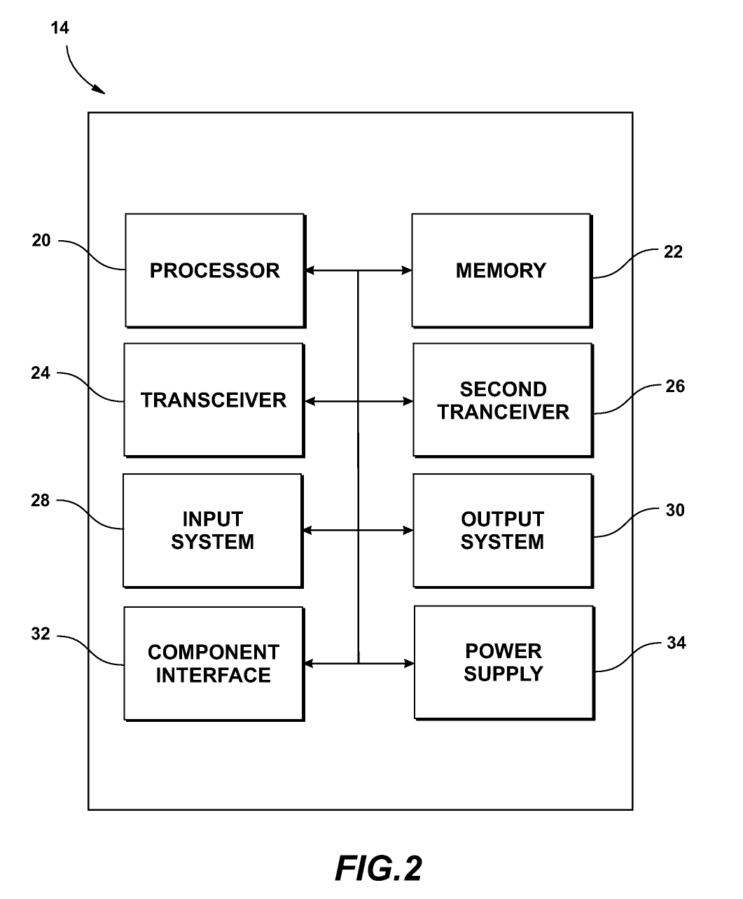

Referring to FIG. 2, an exemplary communication device 14 is shown. The communication device 14 can include a processor 20. The processor 20 may be implemented with one or more general-purpose and/or special-purpose processors. Examples of suitable processors 20 include microprocessors, microcontrollers, DSP processors, and other circuitry that can execute software. The communication device 14 can include memory 22 for storing various types of data. The memory 22 can include volatile and/or non-volatile memory. Examples of suitable memory 22 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 22 can be operatively connected to the processor 20 for use thereby. The term “operatively connected,” as used throughout this description, can include direct or indirect connections, including connections without direct physical contact.

The communication device 14 can further include a transceiver 24. The transceiver 24 can be operatively connected to the processor 20 and/or the memory 22. Any suitable transceiver can be used to access a network, access point, node or other communication device for the transmission and receipt of data. The transceiver 24 may be a wireless transceiver using any one of a number of wireless technologies. Examples of suitable transceivers include a cellular transceiver, broadband Internet transceiver, local area network (LAN) transceiver, wide area network (WAN) transceiver, wireless local area network (WLAN) transceiver, personal area network (PAN) transceiver, body area network (BAN) transceiver, WiFi transceiver, WiMax transceiver, Bluetooth transceiver, 3G transceiver, 4G transceiver, ZigBee transceiver, WirelessHART transceiver, MiWi transceiver, IEEE 802.11 transceiver, IEEE 802.15.4 transceiver, or a Near Field Communication (NFC) transceiver, just to name a few possibilities. The transceiver 24 can include any wireless technology developed in the future.

The communication device 14 can further include a second transceiver 26. The second transceiver 26 can be operatively connected to the processor 20 and/or the memory 22 and/or other components of the communication device 14. As an example, the second transceiver 26 can be used to access a network, access point, node or other communication device, wired or wirelessly, for the transmission and receipt of data with the auxiliary communication device 16. The second transceiver 26 may use any one of a number of wireless technologies, including those mentioned above, and/or may support wired connections. While FIG. 2 shows the communication device 14 as having two separate transceivers 24, 26, it will be appreciated that the functionality of the two transceivers may be performed by a single transceiver.

The communication device 14 can include an input system 28 for receiving inputs from a user. Any suitable input system 28 can be used, including, for example, a keypad, display, touch screen, button, joystick, mouse, trackball, microphone or combinations thereof. The communication device 14 can include an output system 30 for presenting information to the user. The output system 30 can include a display, such as an LCD display and/or a printer. Alternatively or in addition, the output system 30 may include a microphone, earphone and/or speaker. Some components of the communication device 14 may serve as both a component of the input system 28 and a component of the output system 30.

The communication device 14 may include a component interface 32. Additional elements can be operatively connected to the component interface 32, including, for example, a universal serial bus (USB) or other interface. The communication device 14 may include a power supply 34. As is shown in FIG. 2, the processor 20, the memory 22, the transceiver 24, the second transceiver 26, the input system 28, the output system 30, the component interface 32 and/or the power supply 34 can be operatively connected to each other in any suitable manner.

The communication device 14 can collect data regarding the usage of the communication device 14. For instance, the communication device 14 can compile a call history log of all calls received thereby and/or initiated thereon. The call history log can include data on whether a call was accepted or not accepted (which can include declined, unanswered and/or missed calls). If the call was accepted, the call history log can include data on the duration of the call. The call history log can also track the number of times that a call was received by and/or initiated on the communication device 14 to and/or from a particular contact or telephone number. The call history log can also track data on the user's behavior when an incoming call is received while currently in an active call. For instance, the call history log can track the frequency of which the user terminates or holds other calls when the incoming call is from a particular caller or from any caller. The call history log can also track data on whether the user goes back to a previous caller to hang up and then return to a call.

The call history can span any period of time. For instance, the call history can span across the entire history of the communication device 14 or a subset thereof. The period of time of the call history can be for a predetermined period of time (i.e., most recent 3 months), or it can be determined by the user. Still alternatively, the period of time of the call history can be determined randomly. In short, the period of time of the call history can be based on any length of time and/or based on any other criterion, such as memory space or a predetermined maximum number of calls.

Further, the communication device 14 may also determine the time interval between the issuance of commands on the auxiliary communication device 16 and/or the communication device 14. Again, the above listed types of data are intended to be exemplary and are not intended to be an exhaustive list, as the system can gather any information derived from caller or user behavior.

The device 14 can be configured to generate a dynamic call list, which includes all supported calls. “Supported calls” is defined as all active and pending (on hold) calls. A “dynamic call list” is defined as any list of supported calls in any form that is updated to reflect changes to the list of supported calls. The dynamic call list can be updated as call as new incoming calls are received and as supported calls are terminated. The dynamic call list can be updated at any suitable time, including continuously, periodically at regular or irregular intervals, or even randomly. There may or may not be an order to the manner in which the supported calls are listed on the dynamic call list. If ordered, the supported calls on the dynamic call list can be ordered in any suitable manner, including in any manner described herein.

Alternatively or in addition, a user can manually input data as to the relative importance of a phone number or contact. For instance, the communication device 14 can have a contact list. A user can attribute a rank to individual contacts/numbers of the contact list and/or to individual classes of numbers on the contact list to signify the relative importance of a call from a particular number, contact or type of contact. For instance, each individual contact/number on the list can be assigned a rank as to the importance of a call from this number/contact. Alternatively or in addition, the different classes of contacts (including, for example, personal, business, friends, family, etc.) can be assigned a rank as to the importance of a call from such a type of contact. The rank can be assigned to any of a number of additional categories, including company, area code, or other suitable category based on data associated with a particular number. Incoming calls from numbers and/or classes that were not previously ranked can be assigned a default ranking, which may be set by the user or assigned by the communication device 14. The rank can be provided in any suitable form. For instance, the rank can be a numeric value (number, percentage, etc.), a category (high, medium, low, etc.) or other feature (such as color or symbol).

The above described ranking can be input in any suitable manner, such as by the input system 28 of the communication device 14, and can follow any suitable convention. The ranking can indicate the relative importance of the caller to the user and, hence, the probability that the user desires to speak to that person.

As noted above, the system 10 can include an auxiliary communication device 16. The auxiliary communication device 16 can be adapted to receive and output calls thereon handsfree. The term “handsfree” means without the use of hands (for example via voice commands), with minimal use of hands, or for which the controls are positioned so that the hands are readily able to perform another task (such as driving) without needing to search for the controls or divert his or her eyes from the task at hand. The auxiliary communication device 16 can be adapted to allow hands-free talking on the phone.

The auxiliary communication device 16 can be almost any suitable device. In one embodiment, the auxiliary communication device 16 can be a headset, such as a Bluetooth headset. Alternatively, the auxiliary communication device 16 can be a hands-free car kit system or a personal navigation device. The auxiliary communication device 16 can be at least partially supported by and/or mounted on a person's body or a nearby structure.

In some instances, the auxiliary communication device 16 may not be able to directly receive or initiate calls. In such case, calls can be received and/or initiated by the communication device 14. The communication device 14 can communicate with the auxiliary communication device 16 so that the calls are outputted on the auxiliary communication device 16.

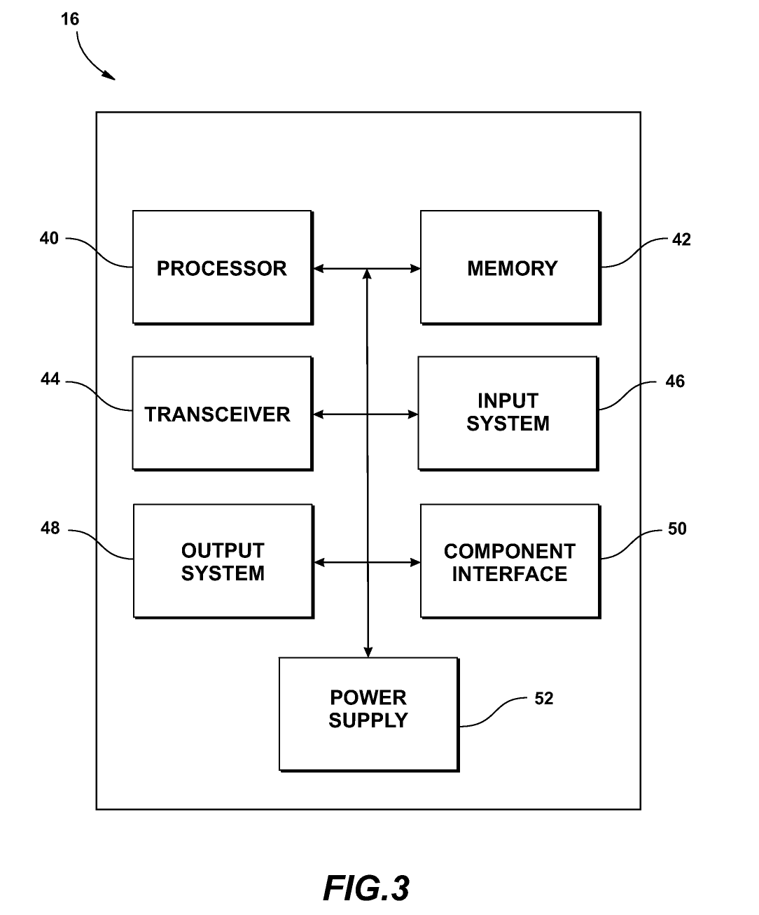

Referring to FIG. 3, an exemplary auxiliary communication device 16 is shown. The auxiliary communication device 16 can include a processor 40, memory 42, and a transceiver 44 for communication with the communication device 14. The above discussion regarding the processor 20, memory 22 and the transceiver 24/second transceiver 26 of the communication device 14 can apply equally to the processor 40, memory 42 and transceiver 44 of the auxiliary communication device 16, respectively.

The auxiliary communication device 16 can include an input system 46 for receiving input from a user. Such input can include commands from a user. Examples of some commands can include accept, decline, hold, terminate or resume a call. Some commands can be combinations of these commands, input as a single command or as a sequence of two separate commands. For instance, the auxiliary communication device 16 can accept terminate/resume, hold/resume, terminate/accept and/or hold/accept commands. When a terminate/resume command is executed, the active call can be terminated and one of the calls on hold can be resumed. When a hold/resume command is executed, the active call can be placed on hold and one of the pending calls (on hold) can be resumed. When a terminate/accept command is executed, the active call can be terminated and an incoming call can be activated. When a hold/accept command is executed, the active call can be placed on hold and an incoming call can be activated. Systems and methods herein describe the manner in which a pending call is selected to be resumed when there are three or more supported calls on the device. The above discussion regarding the input system 28 of the communication device 14 can apply equally to the input system 46 of the auxiliary communication device 16.

The auxiliary communication device 16 can further include an output system 48, a component interface 50, and/or a power supply 52. The above discussion regarding the output system 30, the component interface 32 and the power supply 34 of the communication device 14 can apply equally to the output system 48, a component interface 50, and/or a power supply 52 of the auxiliary communication device 16, respectively.

It should be noted that some embodiments of systems and methods herein may not include an auxiliary communication device. In such case, the systems and methods described herein may be performed on the communication device 14. As an example, systems and methods herein may be suitable for use in connection with communication devices that have display screens that cannot present all pending calls to the user.

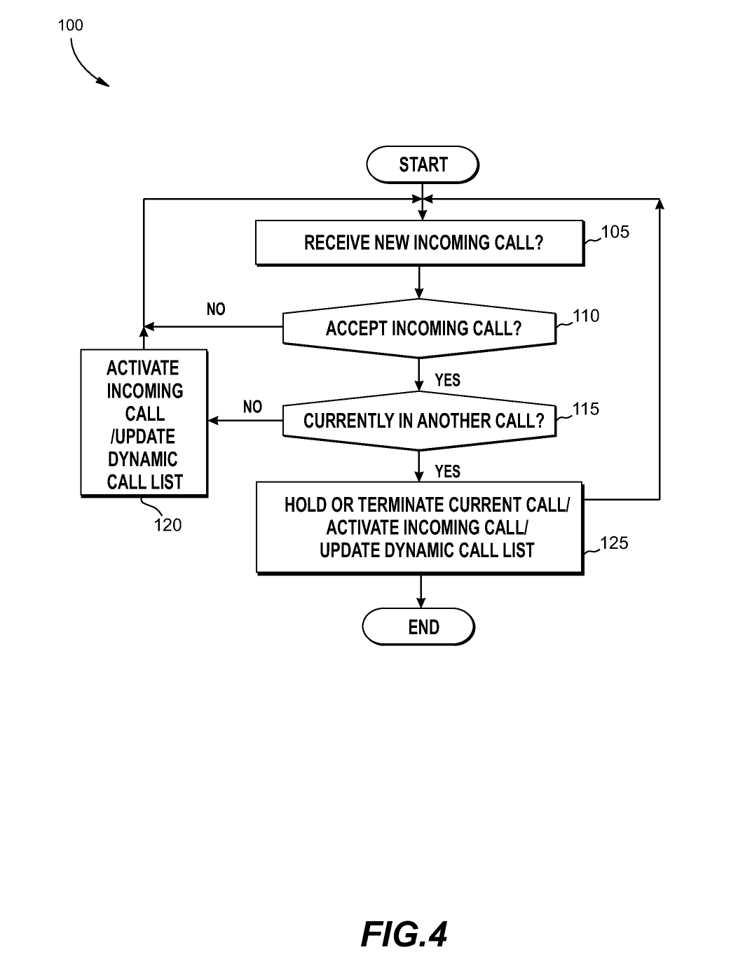

Now that various possible components of a system have been described, one manner of the operation of the system will now be described. The following description is merely provided as an example, and embodiments are not limited to the specific details and steps described. Referring to FIG. 4, an exemplary method 100 for treating incoming calls is shown. The method 100 may include other steps that are not shown here, and in fact, the method 100 is not limited to including every step shown in FIG. 4. It will be understood that the details of method 100 are exemplary, as some embodiments may include additional or fewer steps than those described above. The steps that are illustrated here as part of the method 100 are not limited to this particular chronological order, either. Indeed, some steps may occur in a different order than is shown and/or some steps may occur simultaneously.

Various possible steps of method 100 will now be described. At step 105, a new call can be received on the communication device 14. At decision block 110, it can be determined whether a user command concerning the incoming call has been received. Such a command may also include treatment of an active call. Some of the possible commands that can be input include, for example, accept, hold/accept or terminate/accept. An appropriate command can be input in any suitable manner, including on the input system 28 on the communication device 14 or by executing an appropriate command on the input system 46 on the auxiliary communication device 16. If a command is input, then the method can proceed to decision block 115. If not, then method 100 can return to the start and await another call.

At decision block 115, it can be determined whether the user is in another call. If not, then, at step 120, the incoming call can be activated. The dynamic call list can be updated to include the newly activated call. The dynamic call list may store and/or present the call by any suitable identifier, such as the number, a name or other identifier. The method can return to the start and await another call. On the other hand, if it is determined at decision block 115 that another call is active at the time the incoming call was accepted, then the currently active call can be placed on hold or terminated at step 125. The incoming call can be activated. In addition, the dynamic call list can be updated to include the newly activated call as well as any calls on hold. Such updating would include the removal of any terminated calls from the dynamic call list. After step 125, the method 100 may end or it can return to the start to await a new incoming call.

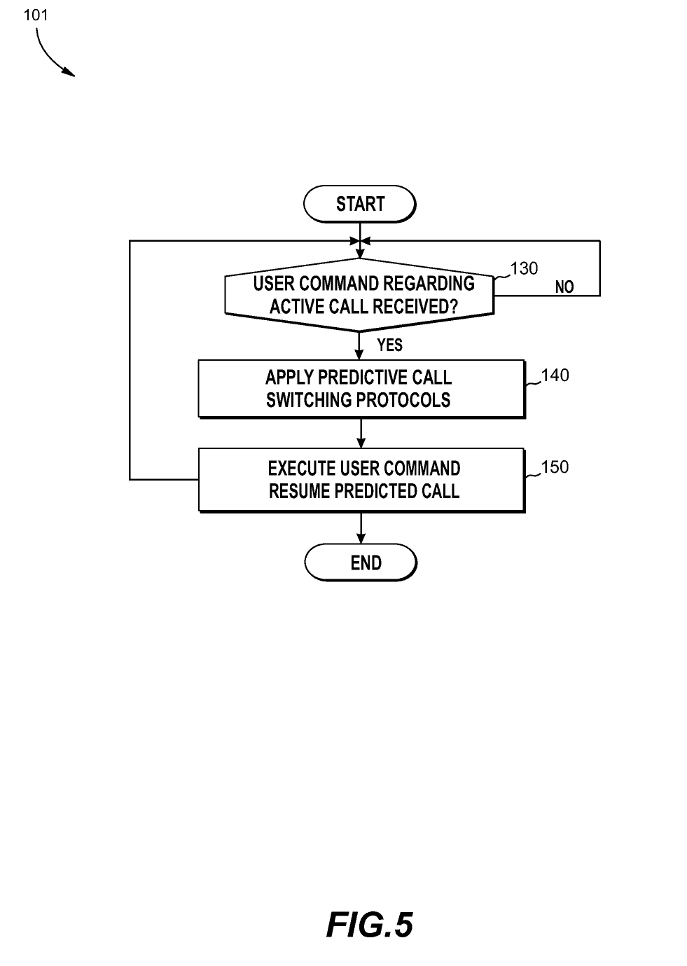

Referring to FIG. 5, an exemplary method 101 for call switching is shown. The method 101 may include other steps that are not shown here, and in fact, the method 101 is not limited to including every step shown in FIG. 5. It will be understood that the details of method 101 are exemplary, as some embodiments may include additional or fewer steps than those described above. The steps that are illustrated here as part of the method 101 are not limited to this particular chronological order, either. Indeed, some steps may occur in a different order than is shown and/or some steps may occur simultaneously. It will be understood that the method 101 may or may not be used in combination with the method 100.

The method 101 can start with the user being in an active call. It should be noted that the method 101 can be used with any number of supported calls on the communication device 14 and/or the auxiliary communication device 16, such as when the supported calls comprise one active call and two or more pending calls. The user can continue in the active call until he or she wishes to do something with the call, such as terminate the call or place it on hold to resume another call or to activate a new incoming call. Thus, at decision block 130, it can be determined whether a command has been received concerning the active call. Some of the possible commands that can be input include, for example, hold, terminate, resume, hold/resume or terminate/resume. Accept, hold/accept or terminate/accept commands may be input if a new incoming call is received. An appropriate command can be input in any suitable manner, including on the input system 28 on the communication device 14 or by executing an appropriate command on the input system 46 on the auxiliary communication device 16.

If a command is not input at decision block 130, then method 101 can return to the start and await another command to be subsequently input. If a command is input, at decision block 130, then the system can implement predictive call switching protocols at step 140. The “predictive call switching protocols” comprises using a predictive analysis based on the evaluation of known information to determine which call supported on the device the user would most likely (highest probability) wish to resume when an active call is placed on hold or terminated and the user wishes to resume one of the pending calls.

At step 140, the predictive calls switching protocols can be used to determine the next pending call to resume. Such predicting can be performed on the communication device 14 and/or on the auxiliary communication device 16, such as on their respective processors 20 and/or 40, respectively, or even some other external device or system. There are various ways in which the predictive calls switching protocols can be implemented. The predictive call switching protocols can be constant, or they can change over time, by user input or in any other way.

Some examples of predictive call switching protocols will be provided. In one implementation, the predictive calls switching protocols can be based on the most frequent callers to and/or from the communication device 14. The determination of the most frequent caller can be made in any suitable manner. For instance, the call history log of the communication device 14 could be queried to determine the most frequent callers to and/or from the communication device 14. Such callers can be the ones who are switched to first when switching between calls using the auxiliary communication device 16. For instance, among the pending calls on the dynamic call list, the caller with the greatest number of entries in the call history could be the first call switched to when terminating the currently active call or placing it on hold, even if that caller's call would not be next call switched to in accordance with conventional call switching. In conventional call switching, the next call switched to will be determined by the order in which the supported calls were received. Thus, the switched to call may not be the one that user is actually interested in switching to and the user may have to go through several calls before getting to the one that is desired. However, by implementing predictive call switching protocols, as described herein, the likelihood that the switched to call is the one that the user wishes to resume can be improved. If the user executes another terminate/resume or hold/resume command, then the next most frequent caller from the pending calls on the call history log could be made the active call.

In another embodiment, the most frequent callers can be determined with respect to only the accepted calls on the call history log. That is, the call history log of the communication device 14 can be reviewed to determine which caller has the greater number or percentage of incoming calls that were accepted. In still another embodiment, the caller on hold with the highest ratio of accepted calls to rejected calls (which may or may not include missed calls) would be the first call activated when switching from an active call to a pending call.

Additionally, each number in a user's contact list may have a ranking associated with it, as set by the user or some other entity. This would indicate the relative importance of the person to the user and hence the probability that the user would wish to speak to that person. Such rankings can be used to determine the next on hold call to activate when a hold/resume or a terminate/resume command is input on the auxiliary device 16 and/or the communication device 14.

The ranking can also be based at least in part on a social media rank. A user may have one or more web-based social media accounts (Facebook, LinkedIn, MySpace, Spoke, Twitter, etc.). One or more of these accounts may be accessible by the communication device 14 and/or the auxiliary communication device 16. In such case, the communication device 14 and/or the auxiliary communication device 16 can access information from such social media accounts as to a caller's rank or from which a caller's rank/priority can be determined.

Such a determination can be made in any suitable manner. For instance, if a particular caller is one of the user's Facebook friends or is otherwise associated with one or more of the user's social media accounts, then that caller may be given a higher or increased priority or rank over callers who are not. Alternatively, if a given caller is associated with more of the user's social media accounts that are accessible by the communication device 14 and/or the auxiliary communication device 16 than other callers, then an increased or higher rank/priority can be assigned to that caller. Still alternatively, callers who are associated with a particular social media account of the user may be given an increased or higher priority/rank. For instance, a user may wish to prioritize his or her business contacts. Accordingly, callers who appear on the user's LinkedIn and/or Spoke account may be given an increased or higher priority/rank over other callers. Of course, other suitable determinations of rank/priority can be made, and the above examples are not intended to be exhaustive.

Temporal characteristics of a user's usage of the communication device 12 and/or the auxiliary communication device 14 may also be used in the predictive call switching protocols. For example, call switching frequency can be used as a variable in determining who the user would likely wish to speak with next. If the amount of time between the issuance of issuing hold/resume and/or terminate/resume commands is below a predetermined threshold, then an appropriate predictive call switching protocol can be implemented. Any suitable predetermined threshold can be selected. For example, the predetermined threshold can be two seconds or less.

Thus, if a user is quickly issuing hold/resume and/or terminate/resume commands from the auxiliary communication device 16, the system could be configured to interpret such actions as an attempt by the user to scroll through the list of calls to get to a specific call that has not yet been selected. In such case, a first predictive call switching protocol can be implemented. However, if the user were to issue a hold/resume and/or terminate/resume command, and then some time later (e.g. 30 seconds or other amount of time above the predetermined threshold) the user were to issue another switch command, such action could be interpreted that the user is most likely attempting to go back to a previous call, not the next call on the dynamic call list. In such case, an appropriate, second call switching protocols can be implemented.

Alternatively or in addition, other temporal characteristics of a user's usage of the communication device 12 and/or the auxiliary communication device 14 may also be used in the predictive call switching protocols.

The processor 20 of the communication device 14 and/or the processor 40 of the auxiliary communication device 16 can use the information above to predetermine the most frequent callers based on the number or entries to and/or from a specific caller within a period of time. The most frequent callers can also be determined based on duration of calls. The communication device 14 and/or the auxiliary communication device 16 can track the duration of calls. The communication device 14 and/or the auxiliary communication device 16 can collect information of the incoming calls that are accepted and the incoming calls that are rejected.

The processor 20 of the communication device 14 and/or the processor 40 of the auxiliary communication device 16 can use location information at least in part as the basis for the predictive call switching protocols. For instance, the current location of the user can be determined relative to the location of the supported callers. Thus, the predictive call switching protocols may assign a higher or increased priority to callers who are in closer proximity to the user or who are located in certain regions, states or countries. Alternatively, the predictive call switching protocols may assign a higher or increased priority to callers who are located farther away or who are located in certain regions, states or countries.

In some embodiments, the communication device 14 and/or the auxiliary communication device 16 can include a positioning system (not shown). The positioning system can be configured to monitor and/or determine the current geographic position of the communication device 14 and/or the auxiliary communication device 16. The positioning system can be any suitable type of positioning system, including, for example, a global positioning system, a local positioning system or a geolocation system. The positioning system may be implemented with any one of a number of satellite positioning systems, such as the United States Global Positioning System (GPS), the Russian Glonass system, the European Galileo system, the Chinese Beidou system, or any system that uses satellites from a combination of satellite systems, or any satellite system developed in the future, including the planned Chinese COMPASS system and the Indian Regional Navigational Satellite System. Information as to the location of the callers may be obtained in any suitable manner. For instance, such information may be provided with the call itself. Such information may be determined and/or provided by the call initiating device 12, the communication network 18, the communication device 14 and/or the auxiliary communication device 16. However such information is obtained, the processor 20 of the communication device 14 and/or the processor 40 of the auxiliary communication device 16 can use such information to determine the proximity of such callers to the user of the communication device 14 and/or the auxiliary communication device 16 using any suitable technique.

Again, the above examples of predictive call switching protocols are intended as exemplary, as the prediction can be based on any suitable information, including any use data described herein. It also should be noted that combinations of two or more of the above predictive call switching protocols can be used to determine which user to switch to. For instance, the determination can be made based on an average of two or more of the above call switching protocols. In one embodiment, each of the constituent call switching protocols comprising the average can have equal weight. In another embodiment, the determination can be made based on a weighted average of constituent factors (including any of the previously described call switching protocols). The weight associated with each component of the average can be predetermined by the user or device manufacturer. Alternatively, the weight associated with each component of the average can be adaptive and can be modified based on user input, such as based on user feedback as to the success of the predictive call switching protocols.

Also, the communication device 14 and/or the auxiliary communication device 16 can include a learning module (not shown). The learning module can collect and analyze data on a user's historical call switching actions. For example, the learning module can detect a user's preferences or behaviors when certain conditions and/or call combinations are present. The learning module can include any of the data noted above in connection with the call history log. Such information can be used by the predictive call switching module to improve the system's predictive capabilities.

Now that various examples of predictive call switching protocols have been described, a description of the method 101 will be continued. At step 150, the user command can be executed and the predicted call in step 140 can be resumed. It should be noted that the communication device on which the predicted call is resumed may or may not be the same as the device on which the prediction is made. In one embodiment, the prediction may be performed on the communication device, and the predicted call can be resumed on the auxiliary communication device. Alternatively, the prediction may be performed on the auxiliary communication device, and the predicted call can be resumed on the communication device. Still alternatively, the prediction may be performed on the communication device, and the predicted call can be resumed on the communication device. Still further alternatively, the prediction may be performed on the auxiliary communication device, and the predicted call can be resumed on the auxiliary communication device. Further, the predicting may be performed on another device entirely, other than the communication device or the auxiliary communication device.

At this point, the method 101 can return to the start to await the input of a user command or the method 101 can end. The dynamic call list can be updated. Another command regarding the resumed call may be input if the user wishes to terminate the call or if the user wishes to place the call on hold. If another call is to be resumed and if the method proceeds to step 140, then a new prediction can be made. This prediction may be based on the same predictive call switching protocols as before. For instance, the on hold call from the next most frequent caller could be activated. If the predictive call switching protocols remain the same, then the call that was resumed but then put back on hold could be temporarily removed from or demoted on the dynamic call list. Alternatively, different predictive call switching protocols can be used.

The user can continue the call until the user inputs a command concerning the active call at step 130 and/or until a new incoming call is received at step 105. In such case, the method 101 can continue in the manner described above.

In some instances, the predictive call switching protocols can be applied only if a certain numbers of calls are supported on the device. In such case, if a command is input at step 130, then the method can include the step of determining the number of calls currently supported on the device, such as by determining the number of calls currently on dynamic call list. Again, the dynamic call list can comprise all supported calls, that is, all active calls and on hold calls. If the number of supported calls is less than a predetermined number of calls, then conventional call switching protocols can be applied at step 140. “Conventional call switching protocols” means the default call switching order on a communication device 14, as predetermined by the manufacturer or otherwise. In such case, the input command can be executed, and the dynamic call list may also be updated. The method 101 can return to the start and await the subsequent input of a command. However, if the number of calls currently supported on the device is greater than or equal to the predetermined number of calls, then the system can implement predictive call switching protocols. In one embodiment, the predetermined number of supported calls can be three.

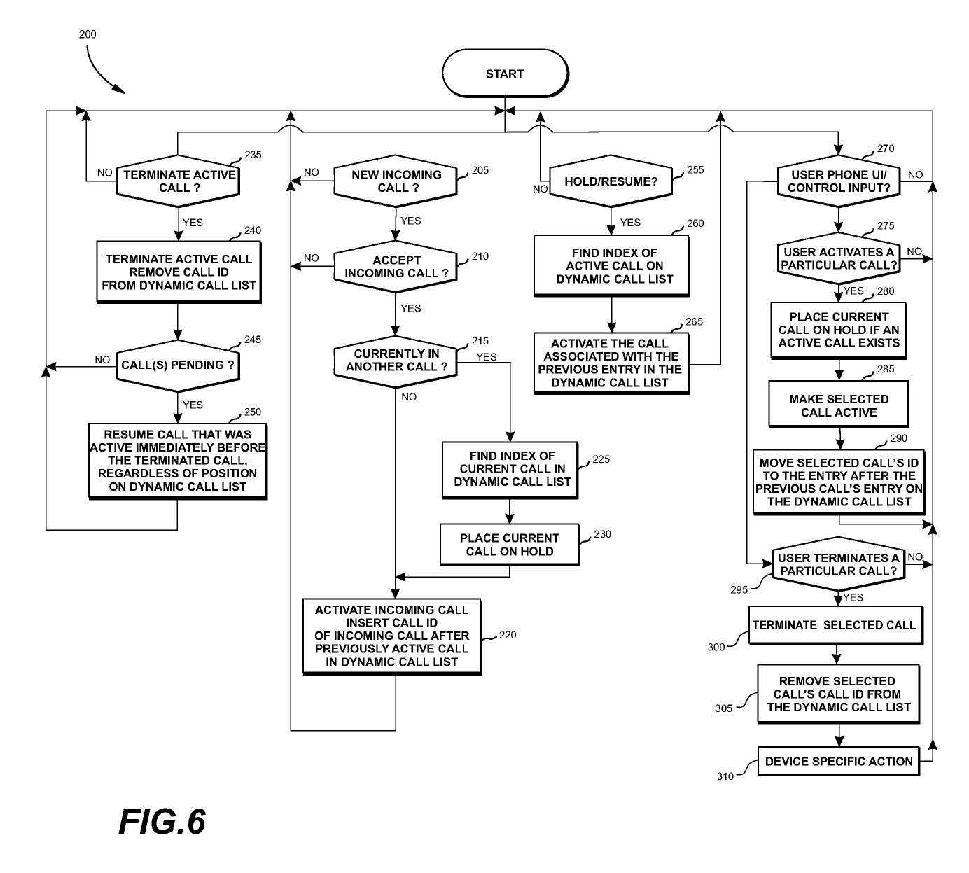

Alternatively or in addition to predictive call switching protocols, systems and methods can implement call switching protocols that can be based on other factors, including, for example, the order the call was received and/or activated and/or the current position within the call list. The method can order and/or resume calls in a non-sequential order based on such factors. One possible implementation of such a method is described below. FIG. 6 shows an example of such a method 200. The method 200 can account for both user actions on the communication device 14 as well as on the auxiliary communication device 16 in order to facilitate the management of call switching between more than two supported calls on the auxiliary communication device 16. The method can provide an intuitive method for navigating through supported calls on the communication device 14, the auxiliary communication device 16 and/or the dynamic call list. Again, these calls may be associated with different phone lines.

The method 200 may include other steps that are not shown here, and in fact, the method 100 is not limited to including every step shown in FIG. 6. It will be understood that the details of method 100 are exemplary, as some embodiments may include additional or fewer steps than those described above. The steps that are illustrated here as part of the method 200 are not limited to this particular chronological order, either. Indeed, some steps may occur in a different order than is shown and/or some steps may occur simultaneously.

Various possible steps of method 200 will now be described. At decision block 205, a new incoming call may or may not be received on the communication device 14. If a new incoming call is not received, then the method 200 can return to the start. If a new incoming call is received, then the method 200 can proceed to decision block 210.

At decision block 210, a user can determine whether or not to accept the incoming call. Acceptance of the incoming call can be performed by executing an appropriate command on the input system 28 on the communication device 14 and/or by executing an appropriate command on the input system 46 on the auxiliary communication device 16. If the call is accepted, then the method can proceed to decision block 215. If the call is not accepted, then method 200 can return to the start and await another call.

At decision block 215, it can be determined whether the user is currently in another call. If the user is not currently in another call, then, at step 220, the incoming call can be activated, and the dynamic call list can be updated to include the newly activated call. For instance, an identifier associated with the newly activated call can be inserted in the dynamic call list. In particular, an identifier associated with the newly activated call can be inserted after the immediately previously active call on the dynamic call list. The method can return to the start and await another call. On the other hand, if it is determined at step 215 that another call was active at the time the incoming call was accepted, then the identifier associated with the current call can be located in the dynamic call list at step 225. The current call can be placed on hold or terminated at step 230. At step 220, the incoming call can be activated. The dynamic call list can be updated to include the newly activated call. For instance, an identifier associated with the newly activated call can be inserted in the dynamic call list after the immediately previously active call on the dynamic call list. The method can return to the start and await another call.

Alternatively or in addition, the user can continue the active call until a user input is provided. For instance, the user may input a command to terminate the call at decision block 235 (or the other participant may terminate the call), input a command to place the call on hold at decision block 255 or provide an input via the communication device 14 at decision block 270. Each of these user input possibilities will be addressed in turn below.

At decision block 235, an input to terminate an active call may or may not be received. If such a command is not received, then the method 200 can return to the start to await a new incoming call or a user input by the communication device 14 and/or the auxiliary communication device 16. If a command to terminate a call is received at decision block 235, such as by an input on the auxiliary communication device 16, then the method can continue to step 240. At step 240, the active call can be terminated. The dynamic call list can be updated to remove an identifier associated with the terminated call from the dynamic call list.

The method 200 can continue to decision block 245 in which it can be determined whether there are any other calls on hold. If no other calls are on hold, then the method 200 can return to the start to await a new incoming call or user input. If there are one or more pending calls on hold, then at step 250, the call that was active immediately before the terminated call was activated can be resumed. This particular call can be resumed regardless of the position of the call on the dynamic call list. The method 200 can return to the start to await a new incoming call or a user input.

At decision block 255, the user may or may not input a hold/resume command. If such a command is not input, then the method 200 can return to the start to await a new incoming call or a user input. If a hold/resume command is input at step 255, such as on the auxiliary communication device 16, then the method can continue to step 260. At step 260, the active call on the dynamic call list can be located. The method 200 can proceed to step 265 in which the call associated with the previous entry on the dynamic call list is activated. The method 200 can return to the start to await a new incoming call or a user input.

As noted above, there may be instances in which a user provides an input by the communication device 14. At decision block 270, it can be determined whether such an input has been received. Such inputs can have any suitable form. For instance, such inputs can include a command to activate a particular call on the dynamic call list. In such case, it can be determined whether such a command has been received at decision block 275. Alternatively, such inputs can include a command to end a particular call on the dynamic call list. In such case, the method can continue to decision block 295. Each of these possibilities will be explained in detail below.

At decision block 275, the user may activate a particular call. For instance, the dynamic call list may be presented to the user, such as on the input system 28 and/or the output system 30 of the communication device 14 or on some other device. In such case, the user can selectively activate a particular call of interest regardless of its position on the dynamic call list. If no such command is input, then the method 200 can return to the start. If a particular call is activated at step 275, then the current call can be placed on hold at step 280, if a current call exists. The selected call can be made active at step 285. An identifier associated with the selected call can be moved on the dynamic call list to a position immediately after the previously active call's entry on the dynamic call list. At this point, the method 200 can return to start.

Alternatively, the user may terminate a particular call at decision block 295. Again, the dynamic call list may be presented to the user in some form, such as on the input system 28 and/or the output system 30 of the communication device 14 or on some other device. If no such command is input, then the method 200 can return to start. If a particular call is selected to be terminated at decision block 295, then the selected call can be terminated at step 300. The identifier associated with the terminated call can be removed from the dynamic call list at step 305.

Next, the method 200 can include the performance of a device specific action at step 310. The term “device specific action” is defined as any action preprogrammed by the manufacturer or user of the device when a particular call is ended. In one embodiment, the device specific action can mean that the last call on the dynamic call list is automatically resumed. Alternatively, the device specific action can mean that the previous call in the dynamic call list is resumed. Still alternatively, the device specific action can mean that any on hold calls remain on hold or unaccepted; that is, when an active call is terminated or placed on hold, one of the pending (on hold) calls is not automatically resumed. The user can have the option to resume a pending call.

Now that the method 200 has been explained in connection with FIG. 6, one example of the operation of the method will be described below. Again, it will be understood that the following discussion is provided merely as an example to illustrate the operation of the method 200. Embodiments herein are not limited to this example. Indeed, it will be recognized that there are numerous possible ways for such a method to operate. To facilitate the discussion, reference will be made to the corresponding steps in the method 200, as shown in FIG. 6.

Assuming there are no currently active or on hold calls, the user can receive and accept new incoming call A (steps 205, 210, 215). Call A can be activated, and an identifier associated with call A can be added to the dynamic call list (step 220). The user can receive new incoming call B (step 205). The user can accept new incoming call B (step 210). Call A can be placed on hold, and new call B can be made active (steps 215, 225, 230, 220). An identifier associated with call B can be inserted on the dynamic call list after call A, the immediately previously active call on the dynamic call list (step 220).

The user can receive and accept new incoming call C (steps 205, 210). Call B can be placed on hold, and call C can be can be made active (steps 215, 225, 230, 220). An identifier associated with call C can be inserted on the dynamic call list after call B, the immediately previously active call on the dynamic call list (step 220). The user can receive and accept new incoming call D (steps 205, 210). Call C can be placed on hold, and call D can be can be made active (steps 215, 225, 230, 220). An identifier associated with call D can be inserted on the dynamic call list after call C, the immediately previously active call on the dynamic call list.

At this point, the dynamic call list would appear as follows:

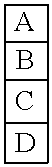

If the user to inputs a hold/resume command (step 255) on the auxiliary communication device 16, then call D can be placed on hold. Based on call D's position on the dynamic call list (step 260), call C—the entry on the dynamic call list before call D—is resumed, according to the switching protocol of method 200. If the user again inputs a hold/resume command (step 255), then call C can be placed on hold. Call B can be made active, according to the switching protocol of method 200, because it is the entry on the dynamic call list immediately before call C.

If a new incoming call E is received (step 205) and accepted (step 210) while call B is the active call, then call B can be placed on hold (step 230) and call E can be made active (step 220). Call E can be inserted into the dynamic call list immediately after call B (step 220) according to the protocols of method 200. At this point, the dynamic call list would appear as follows:

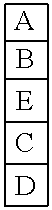

If a hold/resume command is input by the user while call E is the active call (step 255), then, in view of call E's position on the dynamic call list (step 260), call B can be resumed and made the active call (step 265). If call B is then terminated (step 235, 240), then call E can become the active call (step 250), as the switching protocols of method 200 specify that the call that was active immediately before the terminated call is resumed regardless of its position on the dynamic call list. In such case, the dynamic call list would appear as follows:

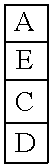

If a command to terminate active call E is input at this point (step 235), then call E can be terminated (step 240) and removed from the dynamic call list. Since there are other calls pending (step 245), call C would be resumed according to the call switching protocols of method 200 because call C was the most recent active call before calls B and E were terminated (step 250). Such call switching protocols can provide a more intuitive and natural order through a call list. It can facilitate a user's progression through a call list in a more efficient manner and may improve the likelihood of the user resuming the desired call.

In contrast, if the user inputs a hold/resume command while call E is the active call (step 255), then call A would be the call that is resumed because it is the entry before call E on the dynamic call list (step 260). Assuming this is the case, the user may input a command on the input system 28 of the communication device 14 (step 270). The command can be, for example, a command to activate a particular call. In this example, the user may enter a command to activate call D (step 275). In such case, call A can be placed on hold (step 280). Call D can be made the active call (step 285) because it is the selected call. The identifier associated with call D can be moved on the dynamic call list to just after call A (step 290)—the immediately previous call—according to the call switching protocols of the method 200. The dynamic call list can be ordered as follows:

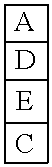

At this point, the issuance of a hold/resume command (step 255) or a terminate/resume command (step 235) can both result in call A being made the active call.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

In light of the above described systems and methods for call switching, it will be appreciated that numerous benefits can be realized. For instance, a user's interaction with the communication device and the auxiliary communication device can be enhanced. In particular, such systems and methods can improve a user's navigation through a call list by an auxiliary communication device, such as a Bluetooth headset. As a result, the amount of time a user spends cycling through the call list to reach the desired call can be minimized, which, in turn, can help to avoid a user's frustration with the device.

Embodiments and aspects herein can be realized in hardware, software, or a combination of hardware and software. Embodiments and aspects herein can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. Embodiments and aspects herein also can be embedded in a computer-readable storage, such as a computer program product or other data programs storage device, readable by a machine, tangibly embodying a program of instructions executable by the machine to perform methods and processes described herein. Embodiments and aspects herein also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects can be embodied in other forms without departing from the spirit or essential attributes thereof. Accordingly, reference should be made to the following claims, rather than to the foregoing specification, as indicating the scope of the invention.

1. A method of switching between calls on a communication system having at least three simultaneously supported calls thereon, the communication system including a communication device, the at least three simultaneously supported calls being currently or previously connected for output on the communication device, the method comprising:
via a processor, predicting one of the supported calls to resume when another one of the supported calls is terminated or put on hold;
switching from the supported call that is terminated or put on hold to the predicted supported call; and
resuming the predicted call for output on the communication device.

2. The method of claim 1, wherein the predicting is based at least partially on data associated with the usage of the communication device.

3. The method of claim 2, wherein the predicting comprises determining which of the supported calls has the greatest number of entries in a call history of the communication device.

4. The method of claim 2, wherein the predicting comprises determining which of the supported calls has the greatest number or percentage of accepted calls from a caller in a call history of the communication device.

5. The method of claim 2, wherein the predicting comprises determining which of the supported calls has the highest ratio of accepted calls to rejected calls in a call history of the communication device.

6. The method of claim 2, wherein the predicting comprises determining which of the supported calls has the greatest single or collective call duration in a call history of the communication device.

7. The method of claim 2, wherein the predicting comprises determining the highest ranked supported call based on a rank associated with each caller.

8. The method of claim 7, wherein a rank is automatically assigned to a caller if a rank has not previously been assigned by a user.

9. The method of claim 2, wherein the predicting is at least partially based on the user's call switching frequency.

10. The method of claim 1, wherein the predicting comprises determining the geographic proximity of the communication device to the location of the supported calls.

11. The method of claim 1, wherein the predicting is at least partially based on data associated with the user's social media accounts.

12. The method of claim 1, wherein the predicting is based on an average of a plurality of factors.

13. The method of claim 1, further comprising:
terminating or holding the resumed call;
predicting a next one of the supported calls to resume when the resumed call is terminated or put on hold; and
resuming the next predicted call for output on the communication device.

14. The method of claim 13, wherein the predicting is based on a different criterion than the previous predicting step.

15. The method of claim 1, wherein the communication device is a portable communication device, a cellular phone, a smart phone, a tablet computer, a computer, a personal digital assistant, an entertainment device, an auxiliary communication device operatively connected to output calls received by another communication device thereon, a handsfree device, or a Bluetooth headset.

16. The method of claim 1, wherein the predicting is performed on a communication device that is different than the communication device on which the predicted call is resumed.

17. The method of claim 1, wherein the predicting is performed on the communication device on which the predicted call is resumed.

18. A communication system including a communication device comprising:
a processor configured to switch between at least three pending calls being simultaneously supported by the communication system, the at least three pending calls being currently or previously connected for output on the communication device, the processor being configured to:
predict one of the supported calls to resume when another one of the supported calls is terminated or put on hold; and
resume the predicted call for output on the communication device.

19. The communication system of claim 18, wherein the predicting is based at least partially on data associated with the usage of the communication device.

20. The communication system of claim 19, wherein the predicting comprises determining which of the supported calls has (a) the greatest number of entries in a call history of the communication device; (b) the greatest number or percentage of accepted calls from a caller in a call history of the communication device; (c) the highest ratio of accepted calls to rejected calls in a call history of the communication device; or (d) the greatest single or collective call duration in a call history of the communication device.

21. The communication system of claim 19 wherein the predicting comprises determining the highest ranked supported call based on a rank associated with each caller.

22. The communication system of claim 21, wherein a rank is automatically assigned to a caller if a rank has not previously been assigned by a user.

23. The communication system of claim 18, wherein the predicting is at least partially based on the user's call switching frequency.

24. The communication system of claim 18, wherein the predicting comprises determining the geographic proximity of the communication device to the location of the supported calls.

25. The communication system of claim 18, wherein the predicting is at least partially based on data associated with the user's social media accounts.

26. The communication system of claim 18, wherein the predicting is based on an average of a plurality of factors.

27. The communication system of claim 18, wherein the communication device is a portable communication device.

28. The communication system of claim 27, wherein the communication device is a cellular phone, a smart phone, a tablet computer, a computer, a personal digital assistant or an entertainment device.

29. The communication system of claim 18, wherein the communication device is an auxiliary communication device operatively connected to output calls received by another communication device thereon.

30. The communication system of claim 29, wherein the auxiliary communication device is a handsfree device.

31. The communication system of claim 30, wherein the handsfree device is a Bluetooth headset.

32. The communication system of claim 18, wherein the processor is provided in the communication device on which the predicted call is resumed.

33. The communication system of claim 18, wherein the processor is provided in a different communication device than the communication device on which the predicted call is resumed.

34. A method of switching between calls on a communication system adapted to simultaneously support at least three calls thereon, the method comprising:
receiving a plurality of incoming calls;
accepting one or more of the incoming calls such that, for each accepted call, any active call is placed on hold and the accepted call is activated for output on a communication device; and
generating a call list in which each accepted incoming call is placed on the call list after the previously active call, whereby the call list is non-sequentially ordered to facilitate progression through the call list.

35. The method of claim 34, further including:
receiving an input to terminate the currently active call;
terminating the currently active call;
removing the terminated call from the call list; and
resuming the call on the call list that was most recently active before the terminated call, regardless of the position of the call on the call list.

36. The method of claim 34, further including:
receiving an input to place the currently active call on hold;
placing the currently active call on hold; and
resuming the call associated with the previous entry on the call list from the call placed on hold.

37. The method of claim 34, further including:
receiving an input to resume a selected call from the call list;
placing any active call on hold;
resuming the selected call; and
moving the selected call to immediately after the previously active call on the call list.

38. The method of claim 34, further including:
receiving an input to terminate a particular call from the call list;
terminating the selected call;
removing the selected call from the call list; and
resuming the call on the call list that was most recently active before the terminated call, regardless of the position of the call on the call list.

39. A communication system comprising:
a processor configured to switch between at least three pending calls being simultaneously supported on the communication system, the processor being configured to:
place an active call on hold and activate the accepted call for output on a communication device in response to receiving an input to accept an incoming call; and
generate a call list in which each accepted incoming call is placed on the call list after the previously active call, whereby the call list is non-sequentially ordered to facilitate progression through the call list.

40. The system of claim 39, wherein the processor is further configured to:
terminate the currently active call when other calls are pending;
remove the terminated call from the call list; and
resume the call that was most recently active before the terminated call, regardless of the position of the call on the call list.

41. The system of claim 39, wherein the processor is further configured to:
place the currently active call on hold; and
resume the call associated with the previous entry on the call list from the call placed on hold.

42. The system of claim 39, wherein the processor is further configured to:
resume a call selected from the call list; and
move the selected call to immediately after the previously active call on the call list.

43. The method of claim 39, wherein the processor is further configured to:
terminate a call selected from the call list; and
remove the selected call from the call list.

44. The communication system of claim 39, wherein the communication device is a portable communication device.

45. The communication system of claim 44, wherein the communication device is a cellular phone, a smart phone, a tablet computer, a computer, a personal digital assistant or an entertainment device.

46. The communication system of claim 39, wherein the communication device is an auxiliary communication device operatively connected to output calls received by another communication device thereon.

47. The communication system of claim 46, wherein the auxiliary communication device is a handsfree device.

48. The communication system of claim 47, wherein the handsfree device is a Bluetooth headset.

49. The communication system of claim 39, wherein the processor is provided in the same communication device on which the accepted call is activated.

50. The communication system of claim 39, wherein the processor is provided in a different communication device than the communication device on which the accepted call is activated.
